(19) United States
(12) Patent Application Publication
(10) Pub. No.: US 2023/0343286 A1
(43) Pub. Date: Oct. 26, 2023

(54) PIXEL STRUCTURE, METHOD FOR DRIVING THE SAME AND DISPLAY SUBSTRATE

(71) Applicants: Hefei BOE Joint Technology Co.,Ltd., Hefei, Anhui (CN); BOE TECHNOLOGY GROUP CO., LTD., Beijing (CN)

(72) Inventors: Jianwei YU, Beijing (CN); Yongqian LI, Beijing (CN); Can YUAN, Beijing (CN)

(21) Appl. No.: 17/913,885

(22) PCT Filed: Oct. 28, 2021
(86) PCT No.: PCT/CN2021/127099

§ 371 Date: Sep. 23, 2022

(30) Foreign Application Priority Data
Mar. 18, 2021 (CN) 202110293125.8

(51) Int. Cl. G09G 3/3233; G09G 3/3291; G09G 3/3266

(52) U.S. Cl. CPC G09G 3/3233; G09G 3/3291; G09G 3/3266; G09G 2300/0426; G09G 2300/0465; G09G 2320/0626; G09G 2300/0452

(57) ABSTRACT

Provided are a pixel structure, a method for driving the same and a display substrate. The pixel structure includes N pixel circuits and a power writing control circuit, N≥2 and N is an integer. Each pixel circuit includes a pixel driving sub-circuit and a light-emitting device. The power writing control circuit provides, according to a voltage regulation control signal, a first power voltage for each pixel circuit in a light-emitting phase. The pixel driving sub-circuit provides, according to a data voltage signal, a driving current for the light-emitting device under the control of a first scanning signal. Light-emitting devices in the pixel circuits are sequentially connected in series, a first electrode of the light-emitting device in the first pixel circuit is connected to the power writing control circuit, a second electrode of the light-emitting device in the N^{th} pixel circuit is connected to a second power terminal.

### TECHNICAL FIELD

The present disclosure relates to the field of display technologies, and specifically relates to a pixel structure, a method for driving the pixel structure and a display substrate.

### BACKGROUND

As a light-emitting device using an organic solid semiconductor as the light-emitting material, the organic light-emitting device (OLED) has a wide application prospect due to the advantages of simple manufacturing process, low cost, low power consumption, high luminous brightness, wide operating temperature range, and the like.

### SUMMARY

To solve at least one of the problems in the related art, the present disclosure provides a pixel structure, a method for driving the pixel structure and a display substrate.

In a first aspect, an embodiment of the present disclosure provides a pixel structure, including N pixel circuits and a power writing control circuit, where N≥2 and N is an integer; and each of the N pixel circuits includes a pixel driving sub-circuit and a light-emitting device; wherein
the power writing control circuit is configured to provide, according to a voltage regulation control signal written to the power writing control circuit, a first power voltage for each of the pixel circuits in a light-emitting phase under the control of a third scanning signal;
for each of the pixel circuits, the pixel driving sub-circuit therein is configured to provide, according to a data voltage signal written to the pixel driving sub-circuit, a driving current for the light-emitting device under the control of a first scanning signal; and
light-emitting devices in the first to N^{th} pixel circuits are sequentially connected in series, a first electrode of the light-emitting device in the first pixel circuit is connected to the power writing control circuit, and a second electrode of the light-emitting device in the N^{th} pixel circuit is connected to a second power terminal.

In some implementations, each of the pixel circuits is provided with one of the light-emitting devices; and the light-emitting devices in the first to N^{th} pixel circuits are sequentially stacked.

In some implementations, except for the light-emitting device in the N^{th} pixel circuit, a second electrode of the light-emitting device in an M^{th} pixel circuit is common to a first electrode of the light-emitting device in an (M+1)^{th} pixel circuit; where 1≤M<N, and M is an integer.

In some implementations, a connection node between the power writing control circuit and the first electrode of the light-emitting device in the first pixel circuit is a first node, the pixel structure further includes a sensing circuit; and
the sensing circuit is configured to sense a potential of the first node under the control of a second scanning signal.

In some implementations, the sensing circuit includes a sensing transistor; and the sensing transistor has a first electrode connected to a sensing signal line, a second electrode connected to the first node, and a control electrode connected to a second scanning line.

In some implementations, the power writing control circuit includes a first control transistor, a second control transistor, and a second storage capacitor;
the first control transistor has a first electrode connected to a voltage regulation signal line, a second electrode connected to a control electrode of the second control transistor and a first plate of the second storage capacitor, and a control electrode connected to a third scanning line; and
the second control transistor has a first electrode connected to a first power terminal, and a second electrode connected to the first electrode of the light-emitting device in the first pixel circuit and a second plate of the second storage capacitor.

In some implementations, the pixel driving sub-circuit at least includes a switch transistor, a driving transistor and a first storage capacitor;
the switch transistor has a first electrode connected to a data line, a second electrode connected to a first plate of the first storage capacitor and a control electrode of the driving transistor, and a control electrode connected to a first scanning line;
the driving transistor has a first electrode connected to the first electrode of the light-emitting device, and a second electrode connected to the second electrode of the light-emitting device; and
a second plate of the first storage capacitor is connected to a third power terminal.

In a second aspect, an embodiment of the present disclosure further provides a method for driving the pixel structure as described above; where the method includes a data writing phase and a light-emitting phase,
in the data write phase, a first scanning signal serves as a working level signal to control pixel driving sub-circuits in N pixel circuits to operate simultaneously, and a data voltage signal is written to each pixel driving sub-circuit; and
in the light-emitting phase, a third scanning signal serves as a working level signal to control a power write circuit to operate, a magnitude of a first power voltage written to the pixel circuits by a first power terminal is controlled by controlling a voltage regulation control signal written to a voltage regulation control line, and a luminous brightness of a light-emitting device in each pixel circuit is controlled according to magnitudes of the first power voltage and the data voltage written to each pixel circuit.

In a third aspect, an embodiment of the present disclosure further provides a display substrate, including a plurality of pixel structures as described above.

In some implementations, the plurality of pixel structures are arranged in an array;
power writing control circuits in the pixel structures in a same row are connected to a same third scanning line; and power writing control circuits in the pixel structures in a same column are connected to a same voltage regulation control line; and
pixel driving sub-circuits in the pixel structures in a same row are connected to a same first scanning line; and pixel driving sub-circuits in the pixel structures in a same column are connected to a same data line.

### BRIEF DESCRIPTION OF DRAWINGS

FIG. 1 is a schematic structural diagram of a pixel circuit in an OLED display panel;

FIG. 2 is a schematic diagram of a pixel structure according to an embodiment of the present disclosure;

FIG. 3 is a schematic diagram of another pixel structure according to an embodiment of the present disclosure;

FIG. 4 is a circuit diagram of a pixel structure according to an embodiment of the present disclosure;

FIG. 5 is a simulation diagram of the pixel structure in FIG. 4 with a voltage regulation control signal of 4V; and

FIG. 6 is a simulation diagram of the pixel structure in FIG. 4 with a voltage regulation control signal of 6V.

### DETAIL DESCRIPTION OF EMBODIMENTS

To improve understanding of the technical solution of the present disclosure for those skilled in the art, the present disclosure will be described in detail with reference to accompanying drawings and specific implementations.

Unless otherwise defined, technical or scientific terms used in the present disclosure are intended to have general meanings as understood by those of ordinary skill in the art. The words “first”, “second” and similar terms used in the present disclosure do not denote any order, quantity, or importance, but are used merely for distinguishing different components from each other. Also, the use of the terms “a”, “an”, or “the” and similar referents do not denote a limitation of quantity, but rather denote the presence of at least one. The word “comprise/comprising” or “include/including” or the like means that the element or item preceding the word contains elements or items that appear after the word or equivalents thereof, but does not exclude other elements or items. The term “connect/connected”, “couple/coupled” or the like is not restricted to physical or mechanical connections, but may include electrical connections, whether direct or indirect connections. The words “upper”, “lower”, “left”, “right”, or the like are merely used to indicate a relative positional relationship, and when an absolute position of the described object is changed, the relative positional relationship may also be changed accordingly.

It should be noted here that the transistor in the embodiments of the present disclosure may be a thin film transistor or field effect transistor or any other device with the same characteristics, and since a source and a drain of the transistor are symmetrical, there is no difference between the source and the drain. In the embodiments of the present disclosure, in order to distinguish the source and the drain of the transistor, one of the source and the drain is referred to as a first electrode, the other of the source and the drain is referred to as a second electrode, and a gate of the transistor is referred to as a control electrode. In addition, transistors may be classified into N-type transistors and P-type transistors according to the characteristics of the transistors. The embodiments below are described by taking an N-type transistor as an example. When the N-type transistor is adopted, the first electrode refers to a source of the N-type transistor, the second electrode refers to a drain of the N-type transistor, and when a high level is input into the gate, the source and the drain are electrically connected. For the P-type transistor, the contrary is true. It is contemplated that the implementation with the P-type transistor can be easily conceived by those skilled in the art without creative efforts, and therefore, also falls within the scope of the embodiments of the present disclosure.

Since the transistor used in the embodiments of the present disclosure is the N-type transistor, a working level signal in the embodiments of the present disclosure refers to a high level signal, and an non-working level signal refers to a low level signal. A corresponding working level terminal is a high level signal terminal, and an non-working level terminal is a low level signal terminal. A first power voltage written to a first power voltage terminal is higher than a second power voltage written to a second power voltage terminal. The embodiments of the present disclosure are described taking the case where first power voltage is a high power voltage and the second power voltage is a low power voltage as an example. A third power voltage input into a third power terminal in the embodiments of the present disclosure is also a low power voltage.

For an OLED display panel with an external compensation function, it includes a plurality of pixel structures arranged in an array and each including N sub-pixels, where N≥2 and N is an integer (in addition, M is 1 or 2 in the embodiments of the present disclosure). Each sub-pixel is provided with a pixel circuit. That is, each pixel structure includes N pixel circuits. Each pixel circuit includes a pixel driving sub-circuit and a light-emitting device. The light-emitting devices of the N pixel circuits in each pixel structure may emit light of a same color or different colors. For convenience of description, in the embodiment of the present disclosure, a case where each pixel structure includes three pixel circuits is taken as an example, and in this case, the light-emitting devices in the three pixel circuits are a red light-emitting device, a green light-emitting device, and a blue light-emitting device, respectively. The light-emitting device in the embodiments of the present disclosure includes, but is not limited to, an organic light-emitting diode, and the following description will be given by taking the light-emitting device as an organic light-emitting diode as an example. One of a first electrode or a second electrode of the organic light-emitting diode is an anode, and the other of the first electrode or the second electrode of the organic light-emitting diode is a cathode. In the embodiments of the present disclosure, the description is given by taking the first electrode being an anode, and the second electrode being a cathode as an example.

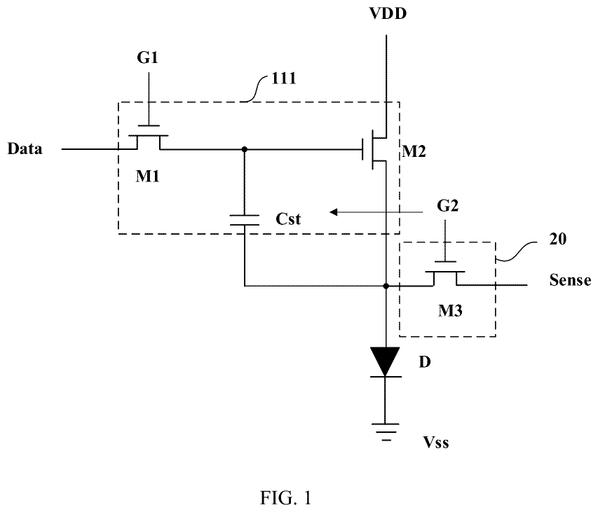

In an example, FIG. 1 is a schematic structural diagram of a pixel circuit in an OLED display panel. As shown in FIG. 1, the pixel circuit includes a pixel driving sub-circuit and an organic light-emitting diode D. The pixel driving sub-circuit includes a switch transistor M1, a sensing transistor M3, a driving transistor, and a storage capacitor Cst. The switch transistor M1 has a source connected to a data line, a drain connected to a first plate of the storage capacitor Cst and a gate of the driving transistor M2, and a gate connected to a first scanning line. The sensing transistor M3 has a source connected to a sensing signal line, a drain connected to a drain of the driving transistor M2 and an anode of the organic light-emitting diode D, and a gate connected to a second scanning line. The driving transistor M2 has a source connected to a first power terminal, and a drain connected to a second plate of the storage capacitor and the anode of the organic light-emitting diode D. The organic light-emitting diode D has a cathode connected to a low power terminal VSS.

A frame of image may be divided into two phases: a display driving phase and a sensing phase. In the display driving phase, display driving is performed on each row of pixel units in the display panel. In the sensing phase, current drawing (i.e., sensing) is performed on some rows of pixel units in the display panel.

In the display driving phase, a high level signal is written to the first scanning line, the switch transistor M1 is turned on, a data voltage Vdata in the data line is written to the gate of the driving transistor M2 to charge the storage capacitor Cst, and the organic light-emitting diode D is driven to emit light by the driving transistor M2.

In the sensing phase, a high level signal is written to the first scanning line and the second scanning line, the sensing transistor M3 and the driving transistor M2 are turned on, a test voltage Vsense is written to the gate of the driving transistor M2 through the data line Data, and an electrical signal at the drain of the driving transistor M2 is read through the sensing transistor M3 and output through the sensing signal line, so that an external compensation circuit compensates a mobility of the driving transistor M2 through the output electrical signal.

It should be noted that the process of performing external compensation on the sub-pixel circuits in the display panel belongs to conventional technologies in the art, and the specific compensation process and principle are not described in detail here.

The inventors have found that in the existing pixel structure, there are many transistors in the driving circuit structure, and an aperture ratio of the pixel in the display panel is limited due to the side-by-side arrangement of the light-emitting devices. In order to solve at least one of the above problems, embodiments of the present disclosure provide the following solutions.

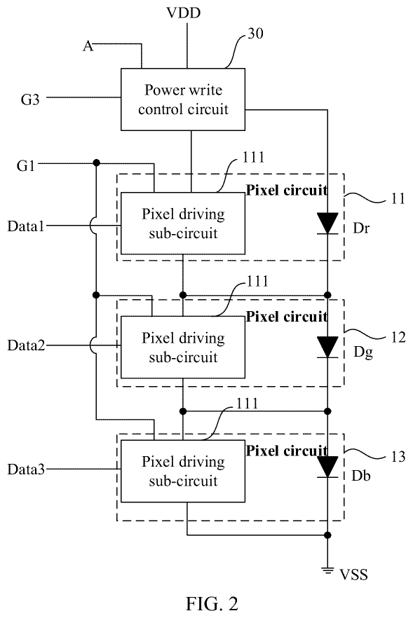

In a first aspect, an embodiment of the present disclosure provides a pixel structure. FIG. 2 is a schematic diagram of a pixel structure according to the embodiment of the present disclosure. As shown in FIG. 2, the pixel structure includes three pixel circuits (11, 12 and 13) and one power writing control circuit 30. Each pixel circuit includes a pixel driving sub-circuit 111 and an organic light-emitting diode. The organic light-emitting diodes in the three pixel circuits are a red light-emitting diode Dr, a green light-emitting diode Dg and a blue light-emitting diode Db, respectively. In the following description, a case where the organic light-emitting diode in the first pixel circuit 11 is a red light-emitting diode Dr, the organic light-emitting diode in the second pixel circuit 12 is a green light-emitting diode Dg, and the organic light-emitting diode in the third pixel circuit 13 is a blue light-emitting diode Db is taken as an example.

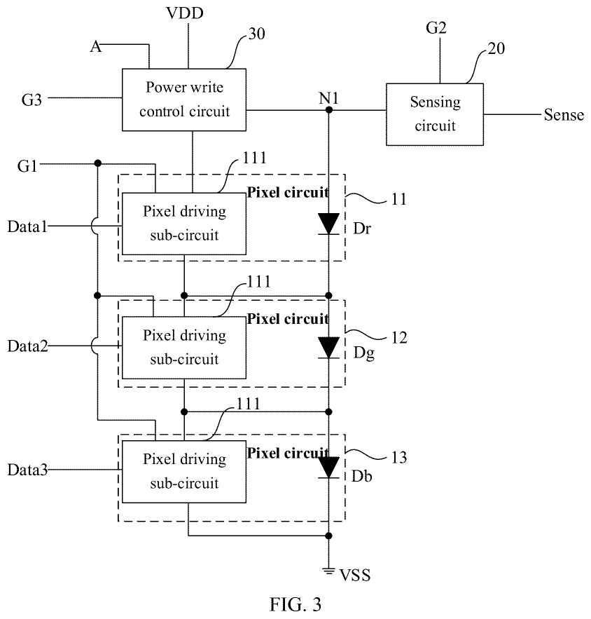

With continued reference to FIG. 3, the power writing control circuit 30 is configured to provide, according to a voltage regulation control signal written to the power writing control circuit, a high power voltage for each of the pixel circuits during the light-emitting phase under the control of a third scanning signal. For each of the pixel circuits 11, the pixel driving sub-circuit 111 therein is configured to provide, according to a data voltage signal written thereto, a driving current for the organic light-emitting diode under the control of a first scanning signal. For example, the pixel driving sub-circuit 111 in the first pixel circuit 11 provides a driving current for the red light-emitting diode Dr according to the data voltage written to the pixel driving sub-circuit 111 in the first pixel circuit 11; the pixel driving sub-circuit 111 in the second pixel circuit 12 provides a driving current for the green light-emitting diode Dg according to the data voltage written to the pixel driving sub-circuit 111 in the second pixel circuit 12; and the pixel driving sub-circuit 111 in the third pixel circuit 13 provides a driving current for the blue light-emitting diode Db according to the data voltage written to the pixel driving sub-circuit 111 in the third pixel circuit 13. The red light-emitting diode Dr, the green light-emitting diode Dg and the blue light-emitting diode Db are sequentially connected in series, an anode of the red light-emitting diode Dr is connected to the power writing control circuit 30, and a cathode of the blue light-emitting diode Db is connected to the low power terminal VSS.

In the pixel structure according to the embodiment of the present disclosure, the pixel driving sub-circuits 111 in the respective pixel circuits are controlled by a same first scanning line G1, and the organic light-emitting diodes are sequentially connected in series, that is, the pixel circuits are combined. In this case, the three light-emitting diodes in the pixel structure can emit light simultaneously. In this way, when sensing the pixel circuits, the sensing may be performed by a same sensing circuit 20, that is, only one sensing circuit 20 is provided in each pixel structure, which helps to simplify the pixel structure, and thus helps to achieve a higher aperture ratio of the pixel in a display panel to which the pixel structure according to the embodiment of the present disclosure is applied.

In some examples, FIG. 3 is a schematic diagram of another pixel structure according to an embodiment of the present disclosure. As shown in FIG. 3, the pixel structure includes not only all the structures of the pixel structure shown in FIG. 2, but also a sensing circuit 20, unlike the pixel structure shown in FIG. 2. With continued reference to FIG. 3, a connection node between the power writing control circuit 30 and the anode of the red light-emitting diode Dr is a first node to which the sensing circuit 20 is connected. The sensing circuit 20 is configured to sense a potential of the first node under the control of the second scanning signal, so as to compensate a mobility or the like of the driving transistor M2 by an external compensation circuit. Obviously, in a reset phase, the sensing circuit 20 may further write an initialization voltage to the first node under the control of the second scanning signal, to initialize each organic light-emitting diode.

As can be seen from FIG. 3, since the organic light-emitting diodes in the pixel circuits in the pixel structure according to the embodiment of the present disclosure are sequentially connected in series, the pixel circuits in the pixel structure may be sensed and reset by a single sensing circuit 20, so that the number of transistors in the pixel structure can be effectively reduced, and the aperture ratio of pixel of the display panel in which the pixel structure is applied can be effectively improved.

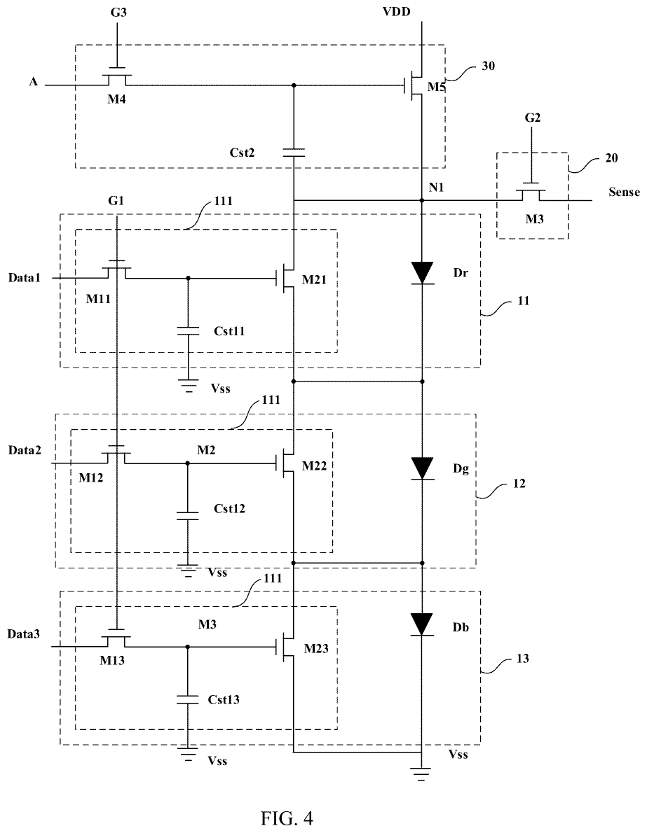

In some examples, FIG. 4 is a circuit diagram of a pixel structure according to an embodiment of the present disclosure. As shown in FIG. 4, the sensing circuit 20 may include a sensing transistor M3. The sensing transistor M3 has a source connected to the first node, a drain connected to a sensing signal line Sense, and a gate connected to the second scanning line G2.

For example, in the sensing phase, the power writing control circuit 30 and the pixel circuit may be operated at the same time, and a test voltage may be written to the data line Data. Meanwhile, when a high level signal is written to the second scanning line G2, the sensing transistor M3 is operated to output a potential of the first node through the sensing signal line Sense, so that the pixel circuit is compensated by the external compensation circuit according to the potential of the first node sensed by the sensing signal line Sense. Apparently, in the reset phase, the sensing transistor M3 may be controlled to operate by writing a high level signal to the second scanning line G2. At this time, an initialization signal is written to the sensing signal line Sense to reset the anode of the red light-emitting diode Dr, and since the red light-emitting diode Dr, the green light-emitting diode Dg and the blue light-emitting diode Db are sequentially connected in series, initialization of the three light-emitting diodes is implemented.

In some examples, with continued reference to FIG. 4, the pixel driving sub-circuit 111 in each pixel circuit includes a switch transistor M1, a driving transistor M2 and a storage capacitor. In the first pixel circuit 11, the switch transistor M11 has a source connected to a data line Data, a drain connected to a gate of the driving transistor M21 and a first plate of the first storage capacitor Cst11, and a gate connected to the first scanning line G1. The driving transistor M21 has a source connected to the power writing control circuit 30 and the anode of the red light-emitting diode Dr, and a drain connected to a source of the driving transistor M22 in the second pixel circuit 12 and the cathode of the red light-emitting diode Dr. A second plate of the first storage capacitor Cst11 is connected to the low power terminal VSS. In the second pixel circuit 12, the switch transistor M12 has a source connected to a data line Data, a drain connected to a gate of the driving transistor M22 and a first plate of the first storage capacitor Cst12, and a gate connected to the first scanning line G1. The driving transistor M22 has a source connected to the drain of the driving transistor M21 in the first pixel circuit 11, the cathode of the red light-emitting diode Dr and an anode of the green light-emitting diode Dg, and a drain connected to a source of the driving transistor M23 in the third pixel circuit 13 and a cathode of the green light-emitting diode Dg. A second plate of the first storage capacitor Cst12 is connected to the low power terminal VSS. In the third pixel circuit 13, the switch transistor M13 has a source connected to the data line Data, a drain connected to a gate of the driving transistor M23 and a first plate of the first storage capacitor Cst13, and a gate connected to the first scanning line G1. The driving transistor M23 has a source connected to the drain of the driving transistor M22 in the second pixel circuit 12, the cathode of the green light-emitting diode Dg and an anode of the blue light-emitting diode Db, and a drain connected to a cathode of the blue light-emitting diode Db and the low power terminal VSS. A second plate of the first storage capacitor Cst13 is connected to the low power terminal VSS. It should be noted that the switch transistors M11, M12, and M13 in the three pixel circuits are connected to a same first scanning line G1, but the sources of the switch transistors M11, M12, and M13 are connected to different data lines Data.

For example, when a high level signal is written to the first scanning line G1, the switch transistors M11, M12, and M13 in the three pixel circuits are all turned on. At this time, a data voltage signal written by a data line Data1 is written to the gate of the driving transistor M21 in the first pixel circuit 11, and then, the luminous brightness of the red light-emitting diode Dr is controlled through the data voltage signal and a voltage regulation control signal written by the power writing control circuit. Meanwhile, a data voltage signal written by a data line Data2 is written to the gate of the driving transistor M22 in the second pixel circuit 12, and then, the luminous brightness of the green light-emitting diode Dg is controlled through the data voltage signal and a voltage regulation control signal written by the power writing control circuit. A data voltage signal written by a data line Data3 is written to the gate of the driving transistor M23 in the third pixel circuit 13, and then, the luminous brightness of the blue light-emitting diode Db is controlled through the data voltage signal and a voltage regulation control signal written by the power writing control circuit. It can be seen that the red light-emitting diode Dr, the green light-emitting diode Dg and the blue light-emitting diode Db emit light simultaneously, and a grayscale value of the pixel structure is determined by a mixed color of the red light-emitting diode Dr, the green light-emitting diode Dg, and the blue light-emitting diode Db.

It should be noted here that the above description merely takes the pixel driving sub-circuit 111 including 2T1C (two transistors and one storage capacitor) as an example. In practical products, depending on the requirements on product performance, the pixel driving sub-circuit 111 may be a circuit of various types, such as 7T1C, 6T2C, and the like, which are not listed here.

In some examples, with continued reference to FIG. 4, the power writing control circuit 30 may include a first control transistor M4, a second control transistor M5, and a second storage capacitor. The first control transistor M4 has a source connected to a voltage regulation signal line A, a drain connected to a gate of the second control transistor M5 and a first plate of the second storage capacitor, and a gate connected to a third scanning line G3. The second control transistor M5 has a source connected to the high power terminal VDD, and a drain connected to the anode of the red light-emitting diode Dr and a second plate of the second storage capacitor.

For example, when a high level signal is written to the third scanning line G3, the first control transistor M4 is turned on, and a voltage written to the anode of the red light-emitting diode Dr from the high power terminal VDD is adjusted by controlling the voltage written by the voltage regulation signal line A, whereby the luminous brightness of each light-emitting diode can be controlled.

In some examples, in the pixel structure according to the embodiment of the present disclosure, the red light-emitting diode Dr, the green light-emitting diode Dg and the blue light-emitting diode Db are sequentially disposed in a stack manner. For example, when the red light-emitting diode Dr, the green light-emitting diode Dg, and the blue light-emitting diode Db are arranged on a base, the three light-emitting diodes are sequentially stacked along a direction away from the base. In this case, the occupied space of the light-emitting diodes in the pixel structure can be effectively reduced, which helps to achieve a higher aperture ratio in a display panel to which the pixel structure according to the embodiment of the present disclosure is applied.

In some examples, since the red light-emitting diode Dr, the green light-emitting diode Dg and the blue light-emitting diode Db are sequentially connected in series and sequentially stacked, the cathode of the red light-emitting diode Dr may be common to the anode of the green light-emitting diode Dg, and the cathode of the green light-emitting diode Dg may be common to the anode of the blue light-emitting diode Db. In this case, it helps to achieve a light and thin display panel to which the pixel structure according to the embodiment of the present disclosure is applied.

In a second aspect, an embodiment of the present disclosure further provides a method for driving a pixel structure, which can be used for driving the pixel structure as described above. The method may include a data writing phase and a light-emitting phase.

In the data writing phase, a first scanning signal serves as a working level signal to control pixel driving sub-circuits 111 in N pixel circuits to operate simultaneously, and a data voltage signal is written to each pixel driving sub-circuit 111.

In the light-emitting phase, a third scanning signal serves as a working level signal to control a power writing control circuit to operate, a magnitude of a first power voltage written to the pixel circuits by a high power terminal VDD is controlled by controlling a voltage regulation control signal written to a voltage regulation control line, and a luminous brightness of the organic light-emitting diode in each pixel circuit is controlled according to magnitudes of the first power voltage and the data voltage written to each pixel circuit.

In order to make the working principle of the pixel structure in the embodiment of the present disclosure clearer, as shown in FIG. 4 below, the case where each pixel driving sub-circuit 111 includes a switch transistor M11 (M12, M13), a driving transistor M21 (M22, M23), and a first storage capacitor Cst11 (Cst12, Cst13); the power writing control circuit 30 includes a first control transistor M4, a second control transistor M5, and a second storage capacitor; and the sensing circuit 20 includes a sensing transistor M3 is taken as an example for description.

Specifically, the pixel driving sub-circuit 111 in each pixel circuit includes a switch transistor, a driving transistor, and a storage capacitor. In the first pixel circuit 11, the switch transistor M11 has a source connected to a data line Data, a drain connected to a gate of the driving transistor M21 and a first plate of the first storage capacitor Cst11, and a gate connected to the first scanning line G1. The driving transistor M21 has a source connected to a second plate of the first storage capacitor Cst11 and the anode of the red light-emitting diode Dr, and a drain connected to a source of the driving transistor M22 in the second pixel circuit 12 and the cathode of the red light-emitting diode Dr. A second plate of the first storage capacitor Cst12 is connected to a low power terminal VSS. In the second pixel circuit 12, the switch transistor M12 has a source connected to a data line Data, a drain connected to a gate of the driving transistor M22 and a first plate of the first storage capacitor Cst12, and a gate connected to the first scanning line G1. The driving transistor M22 has a source connected to the drain of the driving transistor M21 in the first pixel circuit 11, the cathode of the red light-emitting diode Dr and the anode of the green light-emitting diode Dg, and a drain connected to a source of the driving transistor M23 in the third pixel circuit 13 and the cathode of the green light-emitting diode Dg. A second plate of the first storage capacitor Cst12 is connected to the low power terminal VSS. In the third pixel circuit 13, the switch transistor M13 has a source connected to a data line Data, a drain connected to a gate of the driving transistor M23 and a first plate of the first storage capacitor Cst13, and a gate connected to the first scanning line G1. The driving transistor M23 has a source connected to the drain of the driving transistor M22 in the second pixel circuit 12, the cathode of the green light-emitting diode Dg and the anode of the blue light-emitting diode Db, and a drain connected to the cathode of the blue light-emitting diode Db and the low power terminal VSS. A second plate of the first storage capacitor is connected to the low power terminal VSS. In addition, the gates of the switch transistors M11, M12, and M13 in the three pixel circuits are connected to a same first scanning line G1, but the sources of the switch transistors M11, M12, and M13 are connected to different data lines Data. The first control transistor M4 has a source connected to a voltage regulation signal line A, a drain connected to a gate of the second control transistor M5 and the first plate of the second storage capacitor, and a gate connected to a third scanning line G3. The second control transistor M5 has a source connected to a high power terminal VDD, and a drain connected to the first node. The sensing transistor M3 has a source connected to the first node, a drain connected to a sensing signal line Sense, and a gate connected to a second scanning line G2.

The method for driving the pixel structure shown in FIG. 4 specifically includes a data writing phase and a light-emitting phase.

In the data writing phase, a high level signal is written to the first scanning line G1, the switch transistors M11, M12, and M13 in the three pixel circuits are all turned on, a data voltage signal written by the data line Data1 connected to the source of the switch transistor M11 in the first pixel circuit 11 is written to the gate of the driving transistor M21 in the first pixel circuit 11, and stored by the first storage capacitor Cst11. Meanwhile, a data voltage signal written by the data line Data2 connected to the source of the switch transistor M12 in the second pixel circuit 12 is written to the gate of the driving transistor M22 in the second pixel circuit 12, and stored by the first storage capacitor Cst12. A data voltage signal written by the data line Data3 connected to the source of the switch transistor M13 in the third pixel circuit 13 is written to the gate of the driving transistor M23 in the third pixel circuit 13, and stored by the first storage capacitor Cst13.

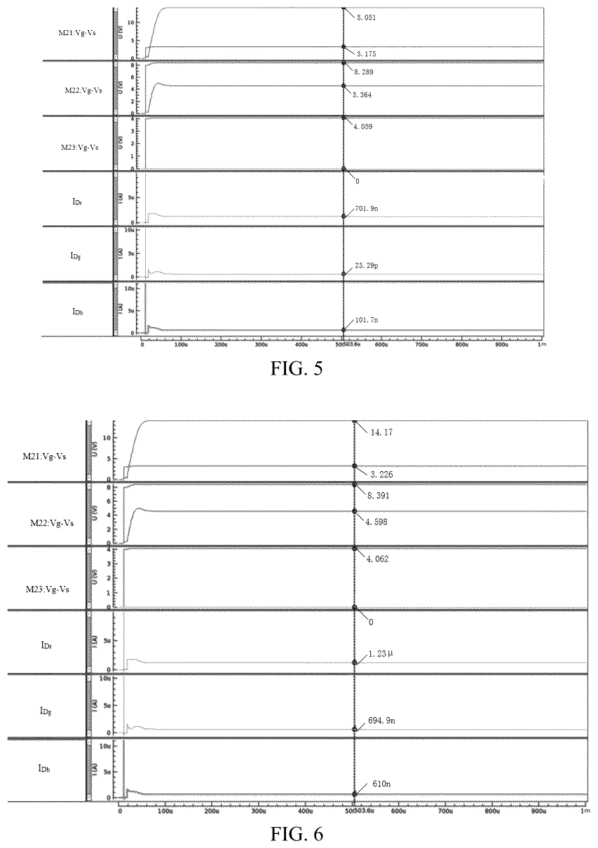

In the light-emitting phase, a high level signal is written to the third scanning line G3, the first control transistor M4 is turned on, and a magnitude of a first power voltage written to the first node by the high power terminal VDD is controlled according to a voltage regulation control signal written by a voltage regulation signal line A. At this time, the luminous brightness of the red light-emitting diode Dr is determined according to magnitudes of the data voltage signal written by the data line Data1 and the first power voltage; the luminous brightness of the green light-emitting diode Dg is determined according to magnitudes of the data voltage signal written by the data line Data2 and the first power voltage; and the luminous brightness of the blue light-emitting diode Db is determined according to magnitudes of the data voltage signal written by the data line Data3 and the first power voltage. Since the first power voltage is constant, the luminous brightness of the red light-emitting diode Dr, the green light-emitting diode Dg, and the blue light-emitting diode Db can be adjusted by adjusting the data voltages written by the data line Data1, the data line Data2, and the data line Data3, respectively, so that color mixing of the red light-emitting diode Dr, the green light-emitting diode Dg and the blue light-emitting diode Db in different proportions can be realized. In addition, for an organic light-emitting diode, the luminous brightness thereof depends on a magnitude of a driving current I_{OLED} flowing therethrough:

$${I}_{OLED} = \frac{1}{2} {μ}_{n} \cdot Cox \cdot \frac{W}{L} \cdot {( Vdata - Voled - Vthn )}^{2}$$

where μₙ is a carrier mobility, Cox is a gate oxide layer capacitance, W/L is a width-to-length ratio of the transistor, Vdata is a data voltage, namely a gate voltage Vg of the driving transistor, Voled is the working voltage of the OLED, which is shared by all pixel driving sub-circuits, namely a source voltage Vs of the driving transistor, and Vthn is a threshold voltage of the transistor, which is a positive value for an enhancement TFT, and a negative value for a depletion TFT. In this regard, a magnitude of a driving current of the organic light-emitting diode depends on Vg and Vs. In the pixel structure according to the embodiment of the present disclosure, however, the gate voltage Vg of each driving transistor depends on the data voltage, the gate voltage Vs of the driving transistor depends on a magnitude of the high power voltage written by the high power terminal VDD, and the magnitude of the high power voltage depends on a magnitude of the voltage regulation control signal. FIG. 5 shows magnitudes of the gate voltages Vg, the source voltages Vs, and the driving currents of the respective red light-emitting diode Dr, green light-emitting diode Dg, and blue light-emitting diode Db when the voltage regulation control signal is at 4V. The gate voltage Vg and the source voltage Vs of the driving transistor M21 in the first pixel circuit 11 are respectively 3.175V and 5.051V, and a driving current I_{Dr} of the red light-emitting diode Dr is 701.9nA. The gate voltage Vg and the source voltage Vs of the driving transistor M22 in the second pixel circuit 12 are respectively 8.289V and 3.364V, and a driving current IDg of the green light-emitting diode Dg is 23.29pA. The gate voltage Vg and the source voltage Vs of the driving transistor M23 in the third pixel circuit 13 are respectively 4.059V and 0V, and a driving current I_{Db} of the blue light-emitting diode Db is 101.7nA. FIG. 6 shows magnitudes of the gate voltages Vg, the source voltages Vs, and the driving currents of the respective red light-emitting diode Dr, green light-emitting diode Dg, and blue light-emitting diode Db when the voltage regulation control signal is at 6V. The gate voltage Vg and the source voltage Vs of the driving transistor M21 in the first pixel circuit 11 are respectively 3.226V and 14.17V, and a driving current I_{Dr} of the red light-emitting diode Dr is 1.23 μA. The gate voltage Vg and the source voltage Vs of the driving transistor M22 in the second pixel circuit 12 are respectively 8.391V and 4.598V, and a driving current I_{Dg} of the green light-emitting device Dg is 694.9nA. The gate voltage Vg and the source voltage Vs of the driving transistor M23 in the third pixel circuit 13 are respectively 4.062V and 0V, and a driving current I_{Db} of the blue light-emitting device Db is 610nA. It can be seen that the magnitudes of the driving currents of the red light-emitting diode Dr, the green light-emitting diode Dg, and the blue light-emitting diode Db at the voltage regulation control signal of 6V are significantly increased compared to those at the voltage regulation control signal of 4V.

In the sensing phase, a high level signal may be written to each of the first scanning line G1 and the third scanning line G3, and a test voltage may be written to each data line Data. Meanwhile, when a high level signal is written to the second scanning line G2, the sensing transistor M3 is operated to output a potential of the first node through the sensing signal line Sense, so that the pixel circuit is compensated by an external compensation circuit according to the potential of the first node sensed by the sensing signal line Sense.

Apparently, the method according to the embodiment of the present disclosure may further include a reset phase in which the sensing transistor M3 may be controlled to operate by writing a high level signal to the second scanning line G2. At this time, an initialization signal is written to the sensing signal line Sense to reset the anode of the red light-emitting diode Dr. Since the red light-emitting diode Dr, the green light-emitting diode Dg and the blue light-emitting diode Db are sequentially connected in series, initialization of the three light-emitting diodes are implemented.

In a third aspect, an embodiment of the present disclosure further provides a display substrate, which may include any one of the structures described above. Therefore, the display substrate according to the embodiment of the present disclosure has a higher aperture ratio of pixel.

In some examples, the plurality of pixel structures are arranged in an array; the power writing control circuits 30 in the pixel structures in a same row are connected to a same third scanning line G3; the power writing control circuits 30 in the pixel structures in a same column are connected to a same voltage regulation control line; the pixel driving sub-circuits 111 in the pixel structures in a same row are connected to a same first scanning line G1; and the pixel driving sub-circuits 111 in the pixel structures of a same column are connected to a same data line Data. In this way, wiring of the display substrate can be simple.

It will be appreciated that the above implementations are merely exemplary implementations for the purpose of illustrating the principle of the present disclosure, and the present disclosure is not limited thereto. It will be apparent to one of ordinary skill in the art that various modifications and variations may be made without departing from the spirit or essence of the present disclosure. Such modifications and variations should also be considered as falling into the protection scope of the present disclosure.

1. A pixel structure, comprising N pixel circuits and a power writing control circuit, wherein N≥2 and N is an integer; and each of the N pixel circuits comprises a pixel driving sub-circuit and a light-emitting device; wherein
the power writing control circuit is configured to provide, according to a voltage regulation control signal written to the power writing control circuit, a first power voltage for each of the pixel circuits in a light-emitting phase under the control of a third scanning signal;
for each of the pixel circuits, the pixel driving sub-circuit therein is configured to provide, according to a data voltage signal written to the pixel driving sub-circuit, a driving current for the light-emitting device under the control of a first scanning signal; and
light-emitting devices in the first to N^{th} pixel circuits are sequentially connected in series, a first electrode of the light-emitting device in the first pixel circuit is connected to the power writing control circuit, and a second electrode of the light-emitting device in the N^{th} pixel circuit is connected to a second power terminal.

2. The pixel structure according to claim 1, wherein each of the pixel circuits is provided with one of the light-emitting devices; and the light-emitting devices in the first to N^{th} pixel circuits are sequentially stacked.

3. The pixel structure according to claim 2, wherein except for the light-emitting device in the N^{th} pixel circuit, a second electrode of the light-emitting device in an M^{th} pixel circuit is common to a first electrode of the light-emitting device in an (M+1)^{th} pixel circuit; wherein 1≤M<N, and M is an integer.

4. The pixel structure according to claim 1, wherein a connection node between the power writing control circuit and the first electrode of the light-emitting device in the first pixel circuit is a first node, the pixel structure further comprises a sensing circuit; and wherein
the sensing circuit is configured to sense a potential of the first node under the control of a second scanning signal.

5. The pixel structure according to claim 4, wherein the sensing circuit comprises a sensing transistor having a first electrode connected to a sensing signal line, a second electrode connected to the first node, and a control electrode connected to a second scanning line.

6. The pixel structure according to claim 1, wherein the power writing control circuit comprises a first control transistor, a second control transistor, and a second storage capacitor;
the first control transistor has a first electrode connected to a voltage regulation signal line, a second electrode connected to a control electrode of the second control transistor and a first plate of the second storage capacitor, and a control electrode connected to a third scanning line; and
the second control transistor has a first electrode connected to a first power terminal, and a second electrode connected to the first electrode of the light-emitting device in the first pixel circuit and a second plate of the second storage capacitor.

7. The pixel structure according to claim 1, wherein the pixel driving sub-circuit at least comprises a switch transistor, a driving transistor and a first storage capacitor;
the switch transistor has a first electrode connected to a data line, a second electrode connected to a first plate of the first storage capacitor and a control electrode of the driving transistor, and a control electrode connected to a first scanning line;
the driving transistor has a first electrode connected to the first electrode of the light-emitting device, and a second electrode connected to the second electrode of the light-emitting device; and
a second plate of the first storage capacitor is connected to a third power terminal.

8. A method for driving the pixel structure according to claim 1; wherein the method comprises a data writing phase and a light-emitting phase,
in the data write phase, a first scanning signal serves as a working level signal to control pixel driving sub-circuits in N pixel circuits to operate simultaneously, and a data voltage signal is written to each pixel driving sub-circuit; and
in the light-emitting phase, a third scanning signal serves as a working level signal to control a power writing control circuit to operate, a magnitude of a first power voltage written to the pixel circuits by a first power terminal is controlled by controlling a voltage regulation control signal written to a voltage regulation control line, and a luminous brightness of a light-emitting device in each pixel circuit is controlled according to magnitudes of the first power voltage and the data voltage written to each pixel circuit.

9. A display substrate, comprising a plurality of pixel structures according to claim 1.

10. The display substrate according to claim 9, wherein the plurality of pixel structures are arranged in an array;
power writing control circuits in the pixel structures in a same row are connected to a same third scanning line; and power writing control circuits in the pixel structures in a same column are connected to a same voltage regulation control line; and
pixel driving sub-circuits in the pixel structures in a same row are connected to a same first scanning line; and pixel driving sub-circuits in the pixel structures in a same column are connected to a same data line.

11. The pixel structure according to claim 2, wherein the power writing control circuit comprises a first control transistor, a second control transistor, and a second storage capacitor;
the first control transistor has a first electrode connected to a voltage regulation signal line, a second electrode connected to a control electrode of the second control transistor and a first plate of the second storage capacitor, and a control electrode connected to a third scanning line; and
the second control transistor has a first electrode connected to a first power terminal, and a second electrode connected to the first electrode of the light-emitting device in the first pixel circuit and a second plate of the second storage capacitor.

12. The pixel structure according to claim 2, wherein the pixel driving sub-circuit at least comprises a switch transistor, a driving transistor and a first storage capacitor;
the switch transistor has a first electrode connected to a data line, a second electrode connected to a first plate of the first storage capacitor and a control electrode of the driving transistor, and a control electrode connected to a first scanning line;
the driving transistor has a first electrode connected to the first electrode of the light-emitting device, and a second electrode connected to the second electrode of the light-emitting device; and
a second plate of the first storage capacitor is connected to a third power terminal.

13. The pixel structure according to claim 3, wherein the power writing control circuit comprises a first control transistor, a second control transistor, and a second storage capacitor;
the first control transistor has a first electrode connected to a voltage regulation signal line, a second electrode connected to a control electrode of the second control transistor and a first plate of the second storage capacitor, and a control electrode connected to a third scanning line; and
the second control transistor has a first electrode connected to a first power terminal, and a second electrode connected to the first electrode of the light-emitting device in the first pixel circuit and a second plate of the second storage capacitor.

14. The pixel structure according to claim 3, wherein the pixel driving sub-circuit at least comprises a switch transistor, a driving transistor and a first storage capacitor;
the switch transistor has a first electrode connected to a data line, a second electrode connected to a first plate of the first storage capacitor and a control electrode of the driving transistor, and a control electrode connected to a first scanning line;
the driving transistor has a first electrode connected to the first electrode of the light-emitting device, and a second electrode connected to the second electrode of the light-emitting device; and
a second plate of the first storage capacitor is connected to a third power terminal.

15. The pixel structure according to claim 4, wherein the power writing control circuit comprises a first control transistor, a second control transistor, and a second storage capacitor;
the first control transistor has a first electrode connected to a voltage regulation signal line, a second electrode connected to a control electrode of the second control transistor and a first plate of the second storage capacitor, and a control electrode connected to a third scanning line; and
the second control transistor has a first electrode connected to a first power terminal, and a second electrode connected to the first electrode of the light-emitting device in the first pixel circuit and a second plate of the second storage capacitor.

16. The pixel structure according to claim 4, wherein the pixel driving sub-circuit at least comprises a switch transistor, a driving transistor and a first storage capacitor;
the switch transistor has a first electrode connected to a data line, a second electrode connected to a first plate of the first storage capacitor and a control electrode of the driving transistor, and a control electrode connected to a first scanning line;
the driving transistor has a first electrode connected to the first electrode of the light-emitting device, and a second electrode connected to the second electrode of the light-emitting device; and
a second plate of the first storage capacitor is connected to a third power terminal.

17. The pixel structure according to claim 5, wherein the power writing control circuit comprises a first control transistor, a second control transistor, and a second storage capacitor;
the first control transistor has a first electrode connected to a voltage regulation signal line, a second electrode connected to a control electrode of the second control transistor and a first plate of the second storage capacitor, and a control electrode connected to a third scanning line; and
the second control transistor has a first electrode connected to a first power terminal, and a second electrode connected to the first electrode of the light-emitting device in the first pixel circuit and a second plate of the second storage capacitor.

18. The pixel structure according to claim 5, wherein the pixel driving sub-circuit at least comprises a switch transistor, a driving transistor and a first storage capacitor;
the switch transistor has a first electrode connected to a data line, a second electrode connected to a first plate of the first storage capacitor and a control electrode of the driving transistor, and a control electrode connected to a first scanning line;
the driving transistor has a first electrode connected to the first electrode of the light-emitting device, and a second electrode connected to the second electrode of the light-emitting device; and
a second plate of the first storage capacitor is connected to a third power terminal.

19. A method for driving the pixel structure according to claim 2; wherein the method comprises a data writing phase and a light-emitting phase,
in the data write phase, a first scanning signal serves as a working level signal to control pixel driving sub-circuits in N pixel circuits to operate simultaneously, and a data voltage signal is written to each pixel driving sub-circuit; and
in the light-emitting phase, a third scanning signal serves as a working level signal to control a power writing control circuit to operate, a magnitude of a first power voltage written to the pixel circuits by a first power terminal is controlled by controlling a voltage regulation control signal written to a voltage regulation control line, and a luminous brightness of a light-emitting device in each pixel circuit is controlled according to magnitudes of the first power voltage and the data voltage written to each pixel circuit.

20. A method for driving the pixel structure according to claim 3; wherein the method comprises a data writing phase and a light-emitting phase,
in the data write phase, a first scanning signal serves as a working level signal to control pixel driving sub-circuits in N pixel circuits to operate simultaneously, and a data voltage signal is written to each pixel driving sub-circuit; and
in the light-emitting phase, a third scanning signal serves as a working level signal to control a power writing control circuit to operate, a magnitude of a first power voltage written to the pixel circuits by a first power terminal is controlled by controlling a voltage regulation control signal written to a voltage regulation control line, and a luminous brightness of a light-emitting device in each pixel circuit is controlled according to magnitudes of the first power voltage and the data voltage written to each pixel circuit.
